(19) United States
(12) Patent Application Publication
(10) Pub. No.: US 2010/0179014 A1
(43) Pub. Date: Jul. 15, 2010

(54) TORQUE DISTRIBUTING DIFFERENTIAL FOR A MOTOR VEHICLE

(75) Inventors: ANDREAS HOHLE, ALSDORF (DE); ACHIM BOOS, LOHMAR (DE); CHRISTOPH CHATENAY, BONN (DE); JOSEF FUHS, INDEN/ALTDORF (DE); KAI-UWE USTORF, KREUZAU (DE); MICHAEL NAGEL, SANKT AUGUSTIN (DE); ULRICH KUKERTZ, LANGERWEHE (DE)

Correspondence Address: CANTOR COLBURN, LLP, 20 Church Street, 22nd Floor, Hartford, CT, 06103, US

(73) Assignee: TEDRIVE HOLDING B.V., NK HEERLEN (NL)

(21) Appl. No.: 12/525,119

(22) PCT Filed: Jan. 30, 2008
(86) PCT No.: PCT/EP2008/051104

§ 371 Date: Mar. 9, 2010

(30) Foreign Application Priority Data
Jan. 31, 2007 (DE) 10 2007 005 730.1

(51) Int. Cl. F16H 48/06

(52) U.S. Cl. 475/253; 475/248

(57) ABSTRACT

The invention relates to a torque-splitting differential (1) for a motor vehicle, comprising two coaxially aligned lateral differential gears (10, 10′) that are spaced apart in the axial direction, each lateral differential gear (10, 10′) being mounted to be rotatable about a common axis of rotation D. The differential has at least two compensating gears (20), each of which meshes with both lateral differential gears (10, 10′). A compensating gear support (30), on which the compensating gears (20) are rotatably mounted and which is arranged between the lateral differential gears (10, 10′), is mounted to be rotatable about the axis of rotation D. The lateral differential gears (10, 10′) are designed as crown gears, of which the teeth have different diameters. Furthermore, the compensating gears (20) are spur-cut gears while the compensating gear support (30) rotatably rests against the lateral differential gears (10, 10′).

The object of the present invention is a torque split differential for a motor vehicle for which the use of a rotating housing accommodating the side differential gears and the compensating gears is not needed. Such differentials with no housing have less weight and a smaller overall space and can usually be manufactured at lower cost over differentials having a housing. The dynamics of the motor vehicle utilizing a differential with no housing is positively influenced since the masses that have to be rotated or sprung are smaller.

Some constructions for differentials with no housing have already been known in prior art. U.S. Pat. No. 6,015,362 discloses for example a differential with no housing with an ring-shaped crown gear in which a carrier for rotatably carrying two compensating gears is disposed. The disadvantage of the differential with no housing disclosed herein is that the way the carrier of the compensating gears is carried in the ring-shaped crown gear is quite complex. Another problem is to devise the differential with no housing disclosed herein so that it is suited for transmitting high torques.

A differential (with perforated housing) for a motor vehicle is known from the document DE 44 41 163 A1, said differential being based on bevel gears. On this differential, the closed housing provided on conventional differentials is replaced by a largely open carrier which connects a crown-shaped ring gear carrying two compensating gears to axially spaced-apart bevel roll bearings. The differential gear known therefrom already has a lower weight but the introduction of an open differential housing does not allow for substantially reducing the overall space.

Differentials with no housing allowing for splitting the torque between two driven shafts have not been known hitherto.

It is therefore the object of the present invention to indicate a torque split differential that is in particular suited for use as a central differential for a motor vehicle and that has less weight and needs less space while having a high torque-carrying capacity.

This object is achieved by a differential having the features of the main claim.

Such a torque split differential thereby comprises two coaxially aligned side differential gears that are spaced apart in the axial direction, each side differential gear being mounted for independent rotation about one common axis of rotation D. Further, at least two compensating gears are provided, each compensating gear meshing with the two side differential gears. Beside the implementation claimed here, which has at least two compensating gears, other implementations with three, four or even more compensating gears are possible and also technically sensible under certain conditions, in particular if an increased torque-carrying capacity of the torque split differential of the invention is desired.

Between the side differential gears there is interposed a compensating gear carrier which in turn rotatably carries the compensating gears. The compensating gear carrier itself is thereby carried for rotation about the axis of rotation D.

In accordance with the invention, the side gears of the differential are configured to be crown gears the toothed surface feature of which has differing outer diameters. The spur geared compensating gears comprise by contrast substantially identical outer diameters.

Finally, the compensating gear carrier rotatably abuts the side differential gears. The rotatable mounting of the compensating gear carrier onto the side differential gears, which is claimed herein and which allows for rotation of the compensating gear carrier about the common axis D of the side differential gears, can be realized technically in different ways. Hereinafter, some implementations will be discussed in closer detail.

The construction of the invention of a torque split differential makes it possible to completely obviate the need for a separately configured rotating differential housing as it is widely known in prior art torque split differentials. As a result, the weight and the overall space of the torque split differential of the invention can be significantly reduced over the prior art constructions without affecting the torque-carrying capacity of the differential.

In a first preferred implementation, the side differential gears and the compensating gear carrier comprise at least one shaft journal and one recess, said recess being configured to complement the shape of the shaft journal for reception thereof. The available alternatives of a configuration of the shaft journal on a side differential gear or on the compensating gear carrier are in principle equivalent in technical terms. For a specific case of application, one or the other embodiment may offer advantages though. It is also preferred to configure the shaft journals so that the compensating gear carrier abuts both side differential gears through a respective shaft journal which engages in a respective, not necessarily separately configured, recess.

Particular advantages are obtained in the first implementation of the differential of the invention if the compensating gear carrier abuts at least one side differential gear in the radial direction through at least one radial bearing. The radial bearing is thereby advantageously disposed in the region in which the one shaft journal engages into the one recess. If two shaft journals are provided, two radial bearings are advantageously provided, each of which being associated with one of the shaft journals.

In the first implementation of the differential of the invention, there is moreover provided at least one axial bearing on the side differential gears for axially supporting the compensating gear carrier, each of these axial bearings being preferably also disposed in the region in which a shaft journal engages into the complementary configuration associated therewith. The axial bearing may in particular be dimensioned and disposed so that it directly surrounds the shaft journal associated therewith.

In a characteristic of the preferred first implementation, the at least one shaft journal is configured integral with one side differential gear. Preferably, both side differential gears form shaft journals and are configured integral therewith. Alternatively, it is also possible to configure the side differential gears to be hollow so that a driven shaft non-rotatably connected to a side differential gear may pass through the side differential gear associated therewith so that the driven shaft forms a shaft journal on the side of the side differential gears that is turned toward the compensating gear carrier. If the shaft journals are configured on the side differential gears, the complementary associated recesses are formed on the compensating gear carrier. Here, it is more specifically possible to configure one unitary central recess that extends through the entire compensating gear carrier instead of two separately configured recesses.

In the technically equivalent implementation in which the at least one shaft journal is formed by the compensating gear carrier, said compensating gear carrier can be formed by a shaft that is non-rotatably connected to the compensating gear carrier. Preferably, two shaft journals are formed, which are disposed on either side of the compensating gear carrier. Instead of a separately configured shaft, which is non-rotatably connected to the compensating gear carrier, the at least one shaft journal, preferably the two shaft journals, may also be configured integral with the compensating gear carrier.

Particular advantages in terms of space need and carrying capacity are obtained if the radial bearings provided for radially carrying the compensating gear carrier are configured to be bush bearings or needle bearings.

In a second implementation, by contrast, the compensating gear carrier abuts through at least one axial bearing at least one side differential gear that has a significantly larger diameter so that it can be disposed in the region of the largest outer diameter of the associated side differential gear between said side differential gear and the compensating gear carrier. It is also particularly preferred to provide two equally dimensioned axial bearings of the type mentioned herein above. The use of axial bearings with large diameter makes it possible to reduce the dimensions of the bearings as a whole without affecting the axial load capacity of the compensating gear carrier.

If, instead of providing the second embodiment with pure axial bearings, one provides it with bearings which have not only a load capacity in the axial direction but also in the radial direction, it is possible to completely obviate the need for separately configured radial bearings for rotatably mounting the compensating gear carrier on the side differential gears. Moreover, the combination provided in the first preferred implementation, which consisted of at least one shaft journal and of at least one complementary recess, which is provided for receiving the shaft journal, can be eliminated. Other advantages are thus obtained in terms of weight of the torque split differential of the invention.

Both in the preferred first implementation and in the preferred second implementation of the differential of the invention, one obtains advantages if, in addition to the axial bearings, which are disposed between the side differential gears and the compensating gear carriers, shims are interposed to set gear backlash between the side differential gears and the compensating gear carriers. During production of the torque split differential gears of the invention, these shims can be chosen individually for every single gear so that the best possible gear backlash is preset on every single differential gear manufactured.

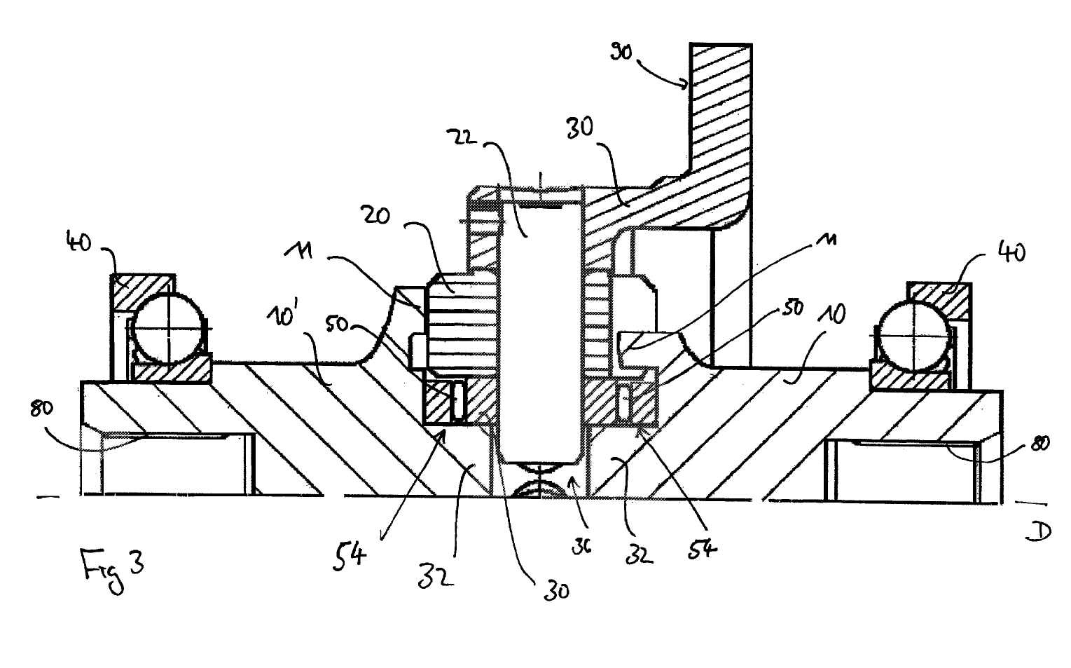

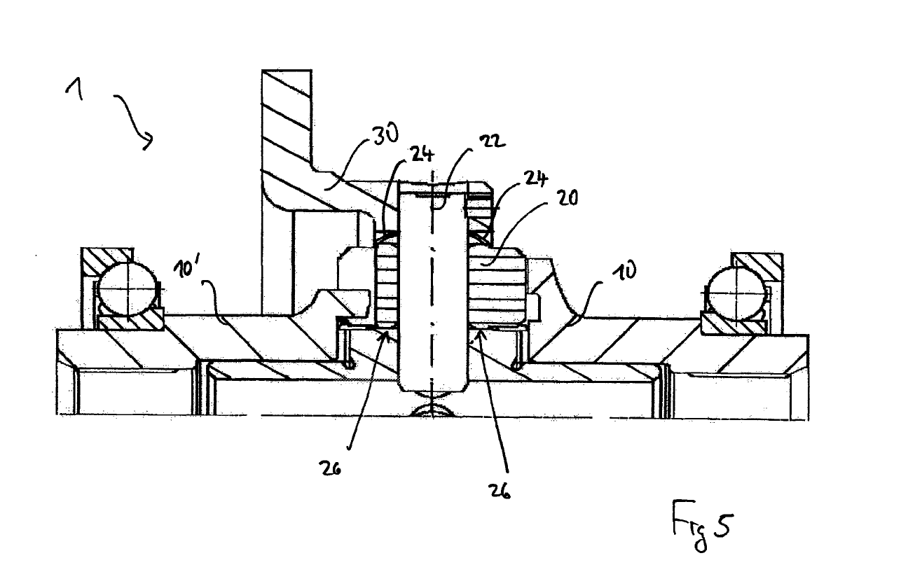

The running characteristics of the torque split differential of the invention can be optimized on the one side by optimally setting gear backlash between the side differential gears and the compensating gears in the way described herein above. In addition or as an alternative thereto, a defined preload force introduced into the differential may positively influence the running characteristics of the differential. For this purpose, the reader is referred to German Patent Application DE 10 2005 036 362, which is also to the holder of the present application. In this patent application, the FIGS. 3 and 5 disclose constructions that allow for applying a defined preload force to a differential of the invention. Details thereof appear from the Figs. referred to as well as from the passages of the mentioned application which refer to these Figs., the content of this application being fully incorporated herein by reference.

The construction mentioned is based on side differential gears that are hollow and on a compensating gear carrier comprising a central recess so that a central bore forms, which extends through both the side differential gears and through the compensating gear carrier in the axial direction. In this central bore, there is inserted a tension axle, which passes through both the central recess of the compensating gear carrier and through the hollow side differential gears. At both ends, the tension axle thereby forms abutments for receiving the split forces between the side differential gears and the compensating gears, which act in the axial direction. By varying the distance between these abutments, the force can be set, which is introduced into the differential of the invention via the tension axle.

Other advantages and features of the differential of the invention will become apparent from the dependent claims and from exemplary embodiments, which will be discussed in closer detail herein after with reference to the drawing. In said drawing:

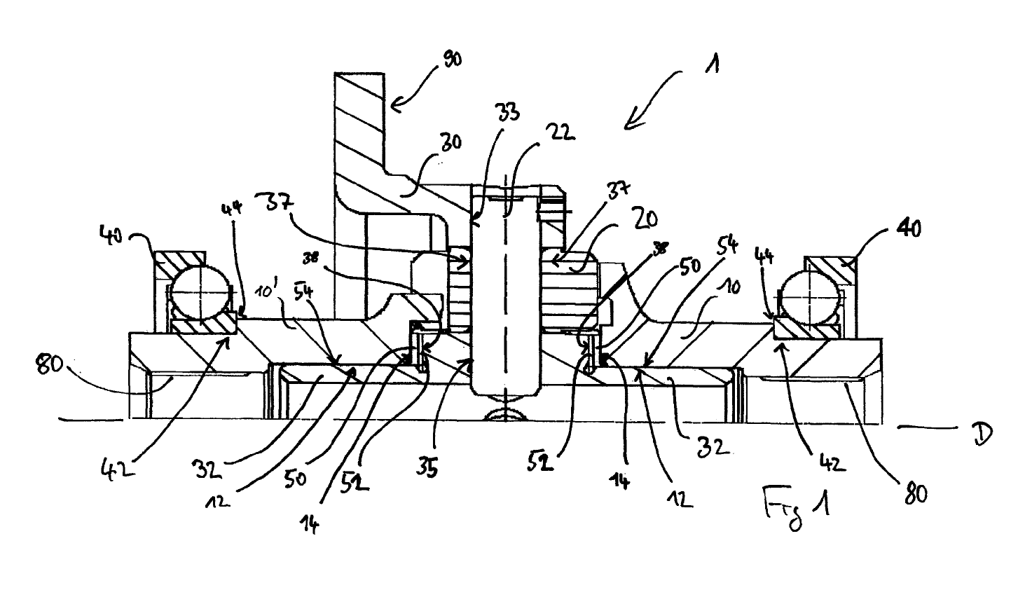

FIG. 1: shows a section through a first implementation of a torque split differential of the invention,

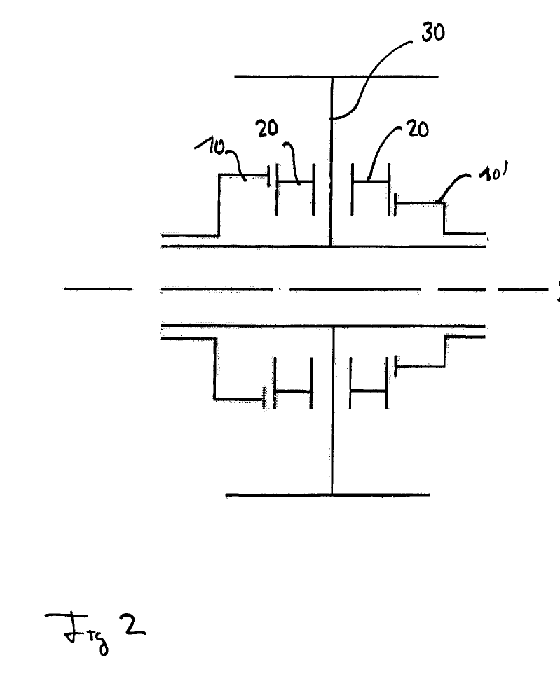

FIG. 2: shows a schematic illustration of the differential shown in FIG. 1,

FIG. 3: shows a sectional view through a third implementation of a torque split differential,

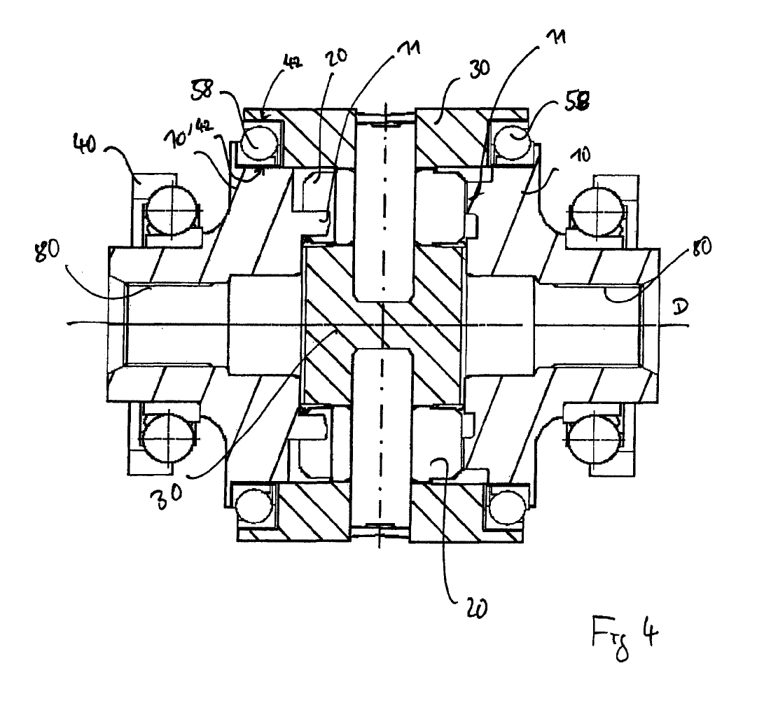

FIG. 4: shows a sectional view through a second implementation of a torque split differential of the invention,

FIG. 5: shows a sectional view through a first developed implementation of the differential shown in FIG. 1 and

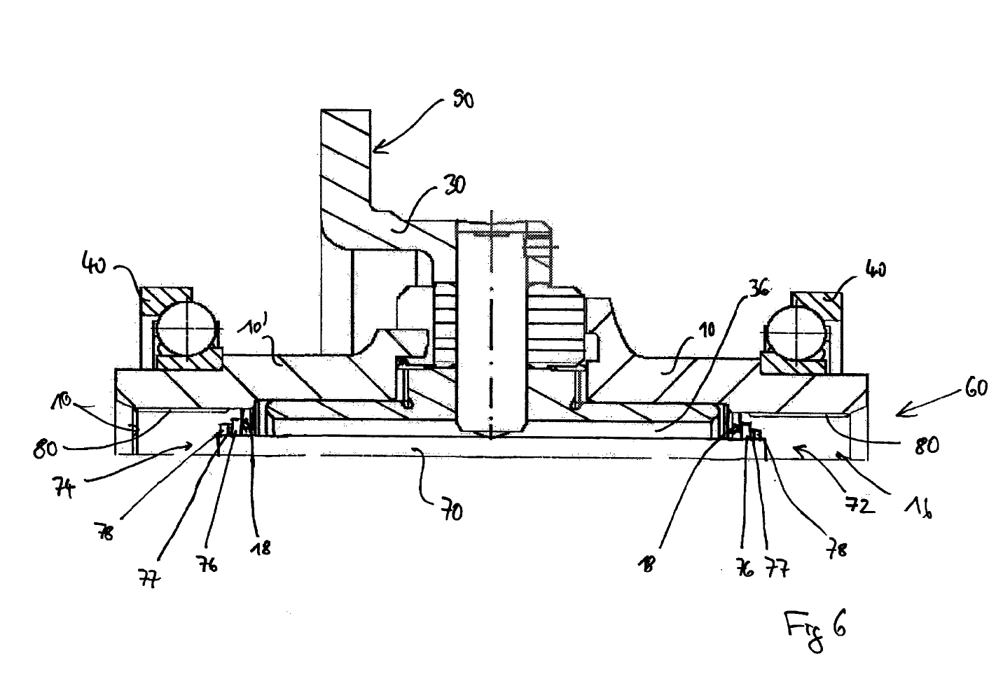

FIG. 6: shows a sectional view through a second developed implementation of the differential shown in FIG. 1.

FIG. 1 shows a first implementation of a torque split differential of the invention in a sectional view taken along the common axis of rotation D of the side differential gears 10, 10′ as well as of the compensating gear carrier 30. The side differential gears 10, 10′ are configured to be crown gears, the outer diameter of the toothed surface feature 11 of the crown gears 10, 10′ differing. The torque split that may be obtained with the differential 1 of the invention between the driven shafts connected to the side differential gears 10, 10′ (not shown) can be set through the ratio of the outer diameters/of the diameters of the toothed surface features of the crown gears.

The side differential gears 10, 10′ mesh with a plurality of compensating gears 20 that are carried on the compensating gear carrier 30 for rotation on a differential pin 22. The compensating gears 30 comprise a spur gear with which the toothed surface feature of the first and of the second side differential gears 10, 10′ meshes. Preferably, there are provided at least two compensating gears 20, which are disposed, evenly distributed over the circumference of the compensating gear carrier 30, in compensating gear windows 37 of the compensating gear carrier 30. To receive the differential pins 22, differential pin bores 33 are provided in the compensating gear carrier 30, said bores extending substantially in the radial direction. The differential pins 22 extend across the compensating gear windows 37 and engage into differential pin receptacles formed in the central region of the compensating gear carrier 30. Furthermore, the compensating gear carrier 30 forms shaft journals 32 on the right and on the left side of its central region. These shaft journals 32 engage into cylindrical recesses 12, which are configured in a complementary shape and which are formed in the first and in the second side differential gear 10, 10′. A shaft journal 32 introduced into a cylindrical recess 12 forms a radial bearing 54 configured to be a sliding bearing for the compensating gear carrier 30 on a respective one of the side differential gears 10, 10′. Instead of the sliding mount realized here, anti-friction bearings may also be utilized as the radial bearings, the use of needle bearings, which may obviate the need for using a bearing race, being preferred to that only a bearing sleeve is utilized. In this case, the circumferential areas of the shaft journals 32 form the bearing surfaces for the needles of the anti-friction bearings.

In the axial direction, the compensating gear carrier 30 abuts the first as well as the second side differential gear 10, 10′ through a respective axial bearing 50. To set gear backlash, a shim 52, which is selected for the discrete differential 1, is further inserted between the compensating gear carrier 30 and the first or second side differential gear 10, 10′. For axially carrying the compensating gear carrier 30 on the side differential gears 10, 10′, the compensating gear carrier forms 2 outward oriented, annular abutment surfaces 38. The side differential gears 10, 10′ form abutment surfaces 14, which are oriented toward the compensating gear carrier 30. The axial bearing 50 as well as the shim 52 fit against these annular abutment surfaces 14, 38.

The side differential gears 10, 10′ are carried in a rigid differential housing, which is not shown in FIG. 1, and which is rotatable about their common axis of rotation D, using bearings 40 which, in the exemplary embodiment shown, are configured to be angular contact ball bearings which may take the forces both in the axial and in the radial direction. For this purpose, the first and the second side differential gears 10, 10′ form bearing seats 42 onto which the inner race of the bearing 40 is pushed until it comes to fit against an abutment shoulder 44, which is also formed by the first and second side differential gears 10, 10′.

FIG. 2 schematically shows once more the relative arrangement of side differential gears 10, 10′, compensating gears 20 and of the compensating gear carrier 30, which is here shown with a spur gearing for connection to a drive shaft. FIG. 2 shows that the compensating gears 20 are carried on the compensating gear carrier 30 for rotation about an axis of rotation that is oriented radially relative to the axis of rotation D. The compensating gears 20 are thereby configured to be spur-geared. A first side differential gear 10 with a gearing having a large outer diameter and a second side differential gear 10′ with a smaller gearing outer diameter mesh with the compensating gears 20. Both side differential gears 10, 10′ are hereby rotatably carried on the compensating gear carrier 30. As already mentioned, the torque split that may be obtained by means of the differential of the invention between driven shafts which are non-rotatably connected to the side differential gears 10, 10′ may be set through the ratio of the diameters of the toothed surface features of the first and of the second side differential gears 10, 10′.

FIG. 3 shows a second implementation of a torque split differential of the invention which coincides substantially with the first embodiment shown in FIG. 1. In particular, the schematic illustration shown in FIG. 2 also applies to the second implementation shown in FIG. 3.

Only the rotatable mounting of the compensating gear carrier 30 on the first and the second side differential gears 10, 10′ differs from that of the first implementation shown in FIG. 1. In the second implementation shown in FIG. 2, the shaft journals 32 of the first and second side differential gears 10, 10′ are formed, the shaft journals 32 engaging into a central bore 36 that is implemented in the center of the compensating gear carrier 30.

The region of the outer circumferential surfaces of the shaft journals 32, which come into contact with the inner circumferential surfaces of the central bore 36 of the compensating gear carrier 30 thereby form a radial bearing configured to be a sliding bearing for carrying the compensating gear carrier 30 for rotation about the axis of rotation D.

In the axial direction, by contrast, the compensating gear carrier 30 abuts the side differential gears 10, 10′ via axial bearings 50 in the exemplary embodiment shown, the diameter of the axial bearings 50 being dimensioned such that the axial bearings 50 are completely disposed inside the toothed surface feature 11 of the first and second side differential gears 10, 10′. In the embodiment shown, the axial bearings used are needle bearings, but it may also be envisaged to use ball bearings as the axial bearings. If, instead of the needle bearings shown, angular contact bearings are utilized for the bearings 50, in particular angular contact ball bearings or conical roller bearings, the radial bearing 54 configured to be a sliding bearing can be eliminated altogether. In this case, a mechanical contact between the shaft journals 32 and the complementary cylindrical recesses 12 is not necessary; the only thing that matters is that both the compensating gear carrier 30 and the first and second side differential gears 10, 10′ comprise suited gear seats with abutment shoulders for the angular contact bearings.

FIG. 4 shows a third implementation of a torque split differential 1 of the invention. Here also, two side differential gears 10, 10′ the toothed surface feature 11 of which comprises different outer diameters, is carried for rotation about a common axis of rotation D. Likewise, for rotatably carrying the side differential gears 10, 10′, one utilizes ball bearings 40 by means of which the side differential gears 10, 10′ are rotatably carried in a stationary differential housing that has not been illustrated herein.

As opposed to the first implementation shown in FIG. 1, the side differential gears 10, 10′ and the compensating gear carrier 30 form no shaft journals and no associated cylindrical recesses configured complementary thereto. Instead, abutment of the compensating gear carrier 30 occurs completely through the rotatable mounting of the compensating gear carrier 30 on the side differential gears 10, 10′. For this purpose, ball bearings 58 are provided in the exemplary embodiment shown, said ball bearings having such a large diameter that they completely surround the toothed surface feature 11 of the side differential gears 10, 10′. On their respective outer circumference, both the first side differential gear 10 and the second side differential gear 10′ form a respective bearing seat 42 for accommodating the inner race of the angular contact bearing 58. Furthermore, the compensating gear carrier 30 also forms a bearing seat for accommodating the outer race of the angular contact bearing 58. Since the angular contact bearings 58, which may for example be configured to be angular contact ball bearings or bevel roll bearings, have a high carrying capacity both in the axial and in the radial direction, the separately configured axial bearings 50 and radial bearings 54 of the first embodiment can be completely eliminated in the illustrated second implementation of the torque split differential 1 of the invention. The abutment known from the first embodiment via a combination of shaft journal and cylindrical recesses configured in complementary fashion thereto on the side differential gears 10, 10′ as well as on the compensating gear carriers 30 are not needed in the third implementation shown.

Like in the exemplary embodiment shown in FIG. 1, the outermost inner circumferential surfaces of the hollow side differential gears 10, 10′ are provided in the third implementation shown in FIG. 4 with an inner toothed surface in the form of splines 80 which are provided for connecting driven shafts.

For simplicity's sake, no ring gear flange 90, which may for example serve to connect a hypoid crown gear, is shown in FIG. 4, as opposed to FIG. 1.

FIG. 5 now shows a first development of the first implementation, known from FIG. 1, of a torque split differential 1 of the invention. The major difference from the implementation shown in FIG. 1 is that spring washers 85 are inserted into the compensating gear windows 37, next to the compensating gears 20, the differential pin 22 also extending through said spring washers. The spring washers 24 serve to press the compensating gears 20 against abutment surfaces 26, which are configured on the compensating gear carrier 30 in the compensating gear windows 37. In this way, the compensating gears 20 can be mounted on the differential pin 22 without backlash. It has been found advantageous to configure the spring washers 24 as convex spring washers which ensure a contact pressure of the compensating gears 20 onto the abutment surfaces 26, said contact pressure being substantially independent from their deformation.

FIG. 6 finally shows a second developed implementation of the torque split differential 1 shown in FIG. 1, in which there is provided a tension axle 70 for applying a defined preload force onto the differential 1. For this purpose, both the first and the second side differential gear 10, 10′ are configured to be hollow, each forming an inner abutment surface 18, which is oriented away from the compensating gear carrier 30. Further, the compensating gear carrier 30 is provided with a central through bore 36 so that a central bore 60 forms, which passes through the entire differential 1. In this central bore 60, there is inserted a tension axle 70 with a first end 72 and with a second end 74. Take-up bearings 76, which are configured to be axial bearings, are plugged onto the first and the second ends 72 and 74 so that the take-up bearings 76 come into abutment on the inner abutment surface 18 of the side differential gears 10, 10′ by their first bearing race. Now, lock nuts 78 for bracing the tension axles are screwed onto the first and the second end 72, 74 of the tension axle 70, whilst inserting washers 77. The take-up bearings 76 thereby form a rotatable mount for the first and second side differential gears 10, 10′. By varying the tightening torque of the lock nuts 78, the preload force, which is introduced into the differential 1, may be varied. Through such a preload of the differential 1, the axial load, which must be carried by the bearings 40 carrying the side differential gears 10, 10′ in the stationary differential housing, can be significantly minimized so that bearings of smaller dimensions can be used. It is also possible to absorb the entire axial load via the tension axle 70 so that pure radial bearings may be utilized for the bearings 40.

The present invention is oriented to the general concept of a torque split differential with no housing, which is recited in the independent claim. The exemplary embodiments shown are to be considered preferred embodiments whilst the invention is not limited to these preferred embodiments.

1. A torque split differential for a motor vehicle comprising:
a. two coaxially aligned side differential gears which are spaced apart in the axial direction, each side differential gear being carried for rotation about a common axis of rotation,
b. at least two compensating gears, each compensating gear meshing with the two side differential gears,
c. a compensating gear carrier interposed between the side differential gears for rotatably carrying the compensating gears, said compensating gear carrier being carried for rotation about the axis of rotation,
wherein
d. the side differential gears are configured to be crown gears that have toothed surface features of different diameters,
e. the compensating gears comprise a spur gearing and
f. the compensating gear carrier being rotatably carried on the side differential gears.

2. The differential as set forth in claim 1, wherein the side differential gears and the compensating gear carrier form
a. a shaft journal,
b. a recess for receiving said shaft journal.

3. The differential as set forth in claim 2, wherein the compensating gear carrier abuts at least one side differential gear via at least one radial bearing in the radial direction, said radial bearing being disposed in the region in which the shaft journal engages the recess.

4. The differential as set forth in claim 1, wherein the compensating gear carrier abuts at least one side differential gear via at least one axial bearing in the axial direction, said axial bearing being disposed in the region in which the shaft journal engages the recess.

5. The differential as set forth in claim 4, wherein the axial bearing is interposed in the region of the largest outer circumference of a side differential gear, between said side differential gear and the compensating gear carrier.

6. The differential as set forth in claim 2, wherein the shaft journal is configured integral with a side differential gear.

7. The differential as set forth in claim 2, wherein the shaft journal is formed by a driven shaft that is non-rotatably connected to the side differential gear and engages therethrough.

8. The differential as set forth in claim 6, wherein the recess is configured to be a central recess that extends through the compensating gear carrier.

9. The differential as set forth in claim 2, wherein the shaft journal is formed by a shaft that is non-rotatably connected to the compensating gear carrier.

10. The differential as set forth in claim 2, wherein the shaft journal is configured integral with the compensating gear carrier.

11. The differential as set forth in claim 1, wherein the shims are interposed between the side differential gears, and the compensating gear carrier in order to set backlash between the side differential gears and the compensating gears.

12. The differential as set forth in claim 2, wherein the radial bearing is configured to be a bush bearing or a needle bearing.

13. The differential as set forth in claim 1, wherein
a. the side differential gears are configured to be hollow and that the compensating gear carrier comprises a central recess so that a central bore forms which extends in the axial direction through the side differential gears and the compensating gear carrier,
b. the differential comprises a tension axle that is inserted in the central bore and passes through the central recess in the compensating gear carrier and through the side differential gears and
c. the tension axle forms abutments at either end for taking the splitting forces acting in the axial direction between the side differential gears and the compensating gears.

14. The differential as set forth in claim 7, wherein the recess is configured to be a central recess that extends through the compensating gear carrier.
